(19) United States
(12) Patent Application Publication
(10) Pub. No.: US 2007/0214178 A1
(43) Pub. Date: Sep. 13, 2007

(54) Multi-project verification environment

(76) Inventors: Thomas J. Sheffler, San Francisco, CA (US); Kevin D. Jones, Hayward, CA (US); Harlan Samuel Lau, Mountain View, CA (US); Kathryn M. Mossawir, Stanford, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 11/374,827

(22) Filed: Mar. 13, 2006

(51) Int. Cl. G06F 17/00

(52) U.S. Cl. 707/104.1

(57) ABSTRACT

A method and apparatus for a multi-project verification environment is provided. A project directory contains files describing commands, designs, tests, and configuration objects. A configuration object contains configuration information describing characteristics of the verification environment for a particular project. For example, the configuration information includes parameters and flags to input to simulation tools, as well as information for tests that are executed on the tools. The commands in the project directory are written in a generic way such that they are appropriate for many different projects. Execution of a command invokes a test script file that is parameterized by values in a configuration object corresponding to the project under test. An entire new verification environment can be generated by specifying a new configuration object, which can be based on a previous configuration object.

### FIELD OF THE INVENTION

A design verification environment is disclosed herein. In particular, the embodiments relate to a multi-project verification environment.

### BACKGROUND

The development of today's complex electronic designs requires design automation. The electronic designs can be very complex and can include both digital and analog hardware, as well as software. A part of the design automation is verification of the design and the models used in the design process. The verification involves a verification environment, which is a work area for performing analyses of Models and designs used in hardware and software. Most typically, the analysis involves applying various test scenarios to a simulation of the design.

The verification environment itself may be an organized file hierarchy with fixed locations for different types of components. Referring to FIG. 1A, a verification environment for ProjectA has commands, design files, and tests. The design files contain descriptions of the specific design. That is, the design files describe ProjectA. The tests describe various test scenarios that are run over the design to verify the design. The commands may be used to invoke test scripts that run the tests over the design. An example of a command to invoke a test script named runtestX with an argument of “t1” is:

% runtestX t1

Tasks are implemented as test scripts that produce log files and other types of results for further analysis. The test scripts describe simulation tools that are used in the design verification and specific tests to be run on the simulation tools. The test scripts may also describe design specific parameters that are input to the simulation tools.

Typically, a given project involves many related designs, all of which need to have a verification environment that is adapted to the specific design. FIG. 1B illustrates a verification environment for ProjectB, which re-uses some of the files from ProjectA. Unfortunately, tailoring a verification environment to a specific design is often laborious and error prone. For example, tailoring a verification environment for a specific design typically involves (1) specifying the set of files that describe the design, and (2) setting parameters and flags for each of the tools invoked by the scripts.

In typical verification environments, this set of files, parameters, and flags is distributed across the environment in an unorganized manner. Indeed, parameters and flags for tools that analyze the design are often tailored by editing the scripts directly, or by setting a few environment variables, making customization a destructive process that leaves the scripts inapplicable to other designs. Scripts describing a particular flow often combine generic and design-specific attributes in a haphazard manner.

The following test script is used to illustrate some problems with tailoring a verification environment to a specific project.
═runtest2 $1═

ncverilog +define+PORTWEDTH2+ d1.v d2.v +PLITEST=$1 +PLIARG=2 −1 $1.log

The example test script has a Verilog macro “PORTWIDTH2” that paramertizes the simulation tool by setting the port width of the design that is specified in the design files “d1.v” and “d2.v”. The test name is an argument to a PLI application, “PLITEST.” The PLI application also requires knowledge of how the simulation tool was parameterized. In this case, the port width is passed as another argument, “PLIARG=2” to the PLI application, wherein the script ensures that the Verilog macro definition and the PLI argument definition match. The test script has a single input that is used to specify the output file. Assume a user runs a test called “t1” with the command:

% runtest2 t1

In this case, the example test script runs the Verilog job, placing its log in the file named “t1.log.” In order to verify a design in which the port width is set to four, a user would typically write a new test script based on the above example. For example, the following test script could be created from the original.
═runtest4 $1 ═

ncverilog +define +PORTWIDTH4+ d1.v d2.v +PLITEST=$1 +PLIARG=4 −1 $1.log

There are multiple problems with this approach. One is that tool flow knowledge (the script) is not effectively shared. Another problem is that the scripts inadvertently both write their output to the same log file when run with the same argument. This prevents the scripts from being run concurrently.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

Embodiments are illustrated by way of example, and not by way of limitation, in the figures of the accompanying drawings and in which like reference numerals refer to similar elements and in which:

FIG. 1A is an illustration of a file hierarchy for a conventional verification environment.

FIG. 1B is an illustration of a file hierarchy for a conventional verification environment that is related to the verification environment in FIG. 1A.

FIG. 2 illustrates a project directory in accordance with an embodiment.

FIG. 3 is a flowchart illustrating steps of a process of executing a test on a circuit design, in accordance with an embodiment.

FIG. 4 is a diagram illustrating a system for a remote job execution in accordance with an embodiment.

FIG. 5A, FIG. 5B, FIG. 5C, and FIG. 5D illustrate various screens in a verification environment navigator in accordance with embodiments.

FIG. 6 illustrates named tunnel for simulation, in accordance with embodiments.

FIG. 7 is a block diagram that illustrates a computer system upon which an embodiment may be implemented.

### DETAILED DESCRIPTION

In the following description, for the purposes of explanation, numerous specific details are set forth in order to provide a thorough understanding of embodiments. It will be apparent, however, that embodiments may be practiced without these specific details. In other instances, well-known structures and devices are shown in block diagram form in order to avoid unnecessarily obscuring embodiments.

### Multi-Project Verification Environment Using Named Configurations Architectural Overview

The Project Directory

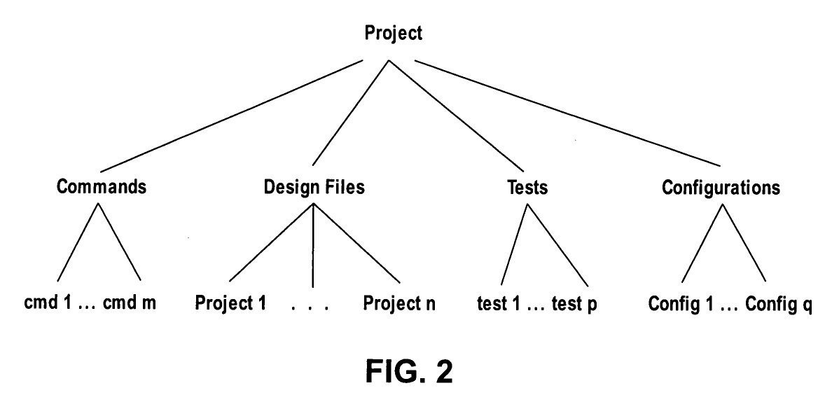

FIG. 2 illustrates a project directory in accordance with an embodiment. The project directory contains files describing commands, designs, tests, and configuration objects. A configuration object contains characteristics of the verification environment for a particular project. A configuration object can be implemented as a file, a series of records in a database, or other object. A particular configuration object serves to describe, for a particular instantiation of a design, characteristics (configuration information) relevant for each tool and flow supported by the verification environment. For example, the configuration information includes parameters and flags to input to simulation tools, as well as information for tests that are executed on the tools. The configuration information also includes a list of design files that include a description of a design under test.

The commands in the project directory are written in a generic way such that they are appropriate for any specific configuration of the project. For example, a command may take an argument that specifies a configuration object, as well as an argument that specifies a test to run. The following is an example of a command that takes as arguments a configuration object and a test name.

% runtest C2 t1

Execution of the example command invokes a test script file. The test script file may be generic and may be parameterized by values in a configuration object. Thus, the command “runtest” can be used for different projects (or different versions of a project) by specifying the configuration object that corresponds to the project.

The design files hold designs that may be used in any of the projects. The design for a particular project can be specified by including particular design files in the configuration object. The test files describe test scenarios that can be run on the designs.

Configuration Objects

A configuration object is a look up table (or dictionary) with key/value pairs that may be referenced to determine design configuration information and test configuration information for the design, in one embodiment. The following is an example of a portion of a configuration object.

=== C2 ===
VDEFINES: “+define+PORTWIDTH2”
VFILES: “d1.v d2.v”
PLIARGS: “+PLIARG=2”

The “VDEFINES” key is used to specify values to parameterize a simulation tool. In this case, the value “+define+PORTWIDTH2” is used to parameterize a simulation tool. In particular, the tool is informed that this particular project has a portwidth of “2”. The “VFILES” key is used to specify design files, such as circuit designs. As used herein, the term “circuit design” includes electronic circuits and other architecture designs implemented in hardware, software, or a combination of hardware and software. As previously discussed, the directory contains a set of design files can be shared among the various projects. The “PLIARGS” key is used to specify arguments for a “PLI” test routine.

A configuration object can include many other types of keys for specifying other designs and test related configuration information. For example, the configuration object may specify what simulation tools to run tests over.

Multiple projects may coexist in the same verification environment, identified by their unique configuration names. The configuration objects describe differences between different verification environments, but share similar components. The following is an example of a configuration object named “C4”, which is similar to the configuration object named “C2”. However, for this project, the port width is “4”.

=== C4 ===
VDEFINES: “+define+PORTWIDTH4”
VFILES: “d1.v d2.v”
PLIARGS: “+PLIARG=4”

Thus, the verification environment supports multiple projects. An entire new verification environment can be generated by specifying a new configuration object, which can be based on a previous configuration object. For example, if a verification environment existed for the project corresponding to configuration object C2, then by adding a configuration object C4, a new verification environment is created. The commands, design files, and test scenarios from the pre-existing verification environment may be used for the new verification environment with little or no modification due to the generic way in which commands, design files, and test scenarios may be specified.

Furthermore, files that are generated by tools used in the verification process are identified by the name of the configuration object for the project, in accordance with an embodiment. For example, files output by tools used in the verification of a particular project have the name of the configuration object associated with the particular project as a part of the file name. Thus, the files associated with the particular project are uniquely identified.

### Process Flow Overview

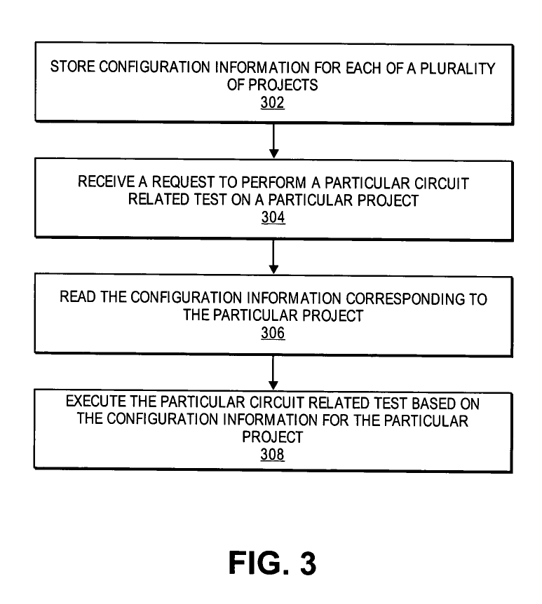

FIG. 3 is a flowchart illustrating steps of a process of executing a test on a circuit design, in accordance with an embodiment. In Step 302, configuration information is stored for each of a plurality of projects. The configuration information for each of the projects specifies at least circuit design files for the project and project specific information relating to circuit related tests to be run on the circuit design files for the project.

The project specific information may describe, but is not limited to, circuit design files, simulation tools on which circuit related tests should be executed, parameters and/or flags to input to one or more simulation tools, parameters to input to a circuit related test to be run on the circuit design files for the project, and a list of circuit related tests to be run on the circuit design files for the project.

Step 304 is receiving a request to perform a particular circuit related test on a particular project. For example, a command such as one of the following is received.

% runtest C2 t1

% runtest C4 t1

In each example command, the second argument specifies that test “t1” be executed. The first argument specifies the configuration object corresponding to the project to run the test on. Thus, the commands can be used to run test “t1” on two different projects, wherein design and test configuration information for the first project is in a configuration object “C2”, and design and test configuration information for the second project is in a configuration object “C4”.

Step 306 is reading the configuration information corresponding to the particular project. For example, a configuration object for either “C2” or “C4” is accessed, depending on the command.

Step 308 is executing the particular circuit related test based on the configuration information for the particular project. Step 308 may include invoking a simulation tool that is specified in the configuration information. Step 308 may include setting parameters and flags for various tools, such as simulation tools. Step 308 may also include providing parameters for various tests to be executed on the particular design. For example, a test may be provided with values of the parameters provided to a simulation tool.

In one embodiment, step 308 includes parameterizing a generic test program with configuration information. The test program is a script in one embodiment. The test program is adapted to be used for many projects by parameterizing the test program based on the configuration information from one of the projects. For example, the following test script can be used to run a test against projects having designs with different port widths, such as those specified in configuration objects C2 and C4.

```
        === runtest $1 $2 ===
    ncverilog ‘cget $1 VDEFINES‘ ‘cget $1 VFILES‘ +PLITEST=$2
‘cget $1 PLIARGS‘ −1 $2-$1.log
```

The test script takes two arguments as input “$1” and “$2”. The first argument identifies a configuration object, and the second argument identifies a test to run. The routine “cget” that is identified in the script is used to extract values from the configuration objects. The above test script provides a macro definition to the Verilog program that is obtained from the identified configuration object. In particular, the Verilog macro provided is the value associated with the “VDEFINES” key in the identified configuration object.

The design files over which the test or tests are to be run are also obtained from the configuration object. In particular, the value associated with the key “VFILES” is extracted from the configuration object by the “cget” routine.

PLITEST is also provided as the second argument ($2), which specifies the test to run against the design files. The test is also provided arguments that are extracted from the configuration object. In particular, the “cget” routine extracts the value associated with the “PLIARGS” key in the configuration object. That value is made available to “PLITEST”.

The output of the test is put in a log file that is uniquely identified by a name that includes the configuration object, as specified by the argument $1. For example, if the configuration object is named “C1” and the test is “t1”, then the log file will be named “t1-C1.log”, in this example. Thus, it is readily discernable which project is associated with the log file. Many other types of files that are generated by various tools can also be clearly associated with a particular project by incorporating the configuration name (or other unique identifier of the configuration object) into the file name. The file is an intermediate file, in one aspect.

Thus, the same generic test script can be used over and over for different projects. Moreover, the environment does not need to be cloned and modified for each project. Rather, a common environment is used for multiple projects.

A variety of techniques can be used to extract the information from the configuration object. The variety of techniques used to extract the configuration information allow the configuration information to be made available to different tools in the verification environment that need to configuration information. One technique to extract configuration information is a script file to parse the configuration object and determine which parameters are pertinent to a given tool and provide those parameters to the tool. Another technique is a C-program that extracts the configuration information from the configuration object. Still another technique is a translator, which translates the configuration information to a format understood by another language, such as a high level verification language (HVL).

### Configuration Composition

In a verification environment organized around named configuration objects, many configurations are closely related to a previously defined configuration. It is advantageous to exploit similarities so that environment changes common to multiple configurations are easily expressed without editing every configuration dependent on that change. Composition operators allow one configuration object to be expressed based on a previously defined configuration object, in accordance with an embodiment. Composition operators include, but are not limited to, an inheritance operator and an inclusion operator.

Inheritance

As previously discussed, a configuration object may be defined in terms of key:value pairs. A configuration object may be described by inheriting key:value pairs from another configuration. Selected inherited key:value pairs can be overridden to establish the differences.

The example below shows how the configuration object “C4” has a key:value pair “INHERIT: C2” that is used to inherit all of the key:value pairs from configuration object C2. Selected values are then overridden, as specified in the values for the keys “VDEFINES” and “PLIARGS.” This representation shows explicitly that configuration object C4 differs from configuration object C2 only in these keys. Configuration object C4 uses the same design files as configuration object C2, as specified in the “VFILES” key.

```
=== C2 ===
  VDEFINES: “+define+PORTWIDTH2”
  VFILES: “d1.v d2.v”
  PLIARGS: “+PLIARG=2”
  === C4 ===
  #INHERIT: C2
  VDEFINES: “+define+PORTWIDTH4”
  PLIARGS: “+PLIARG=4”
```

Inclusion

An inclusion operator allows a previously defined configuration object, or fragment thereof, to be included in another configuration object, in accordance with an embodiment. The example below shows how both configuration objects “C2” and “C4” might be defined as including an incomplete configuration object “ROOTCFG” that includes only design files in this example. However, the “ROOTCFG” could have other keys.

=== ROOTCFG ===
VFILES: “d1.v d2.v”
=== C2 ===
#INCLUDE: ROOTCFG
VDEFINES: “+define+PORTWIDTH2”
PLIARGS: “+PLIARG=2”
=== C4 ===
#INCLUDE: ROOTCFG
VDEFINES: “+define+PORTWDTH4”
PLIARGS: “+PLIARG=4”

It is not required that the entire configuration object be included in the new configuration object. In one aspect, a fragment of the previously defined configuration object is included. A fragment can include a subset of the key/value pairs from the previously defined configuration object, without including all of the key/value pairs. A fragment can include one or more keys, without the associated value or values. A fragment can include one or more values, without the associated key or keys.

Thus, there may be a root configuration object, which does not necessarily correspond to any particular project. Any changes made to the root configuration are inherited to all of the configuration objects that include the root configuration. Child configuration objects can be formed off from any configuration object.

A tool reads the hierarchy of configuration objects and builds the configuration objects as it traverse the hierarchy, in accordance with one embodiment.

### Template Pre-Processing Using Named Configurations

A file-dependency checker is used to determine if a test script is missing dependencies, in accordance with an embodiment. The dependencies may be explicitly defined in the test script. If the test script is missing dependencies, a template pre-processor automatically generates the missing files based on information in the configuration object and a template file.

File-Dependency Checker

The file dependency checker analyzes a script file (e.g., test script) to determine if there are any missing dependencies. Shown below is an example test script augmented with information that shows its dependencies on generated files. The first argument “$1” is for a configuration object. The second argument “$2” is for a test name. Here, the test script “runtest” has a declared dependency showing that when it is invoked with a configuration object argument “D2”, it depends on the file “D2-top.v”. The file “D2-top.v” is automatically generated by the template pre-processor based on a template file and a configuration object, in accordance with an embodiment.

```
  === runtest $1 $2 ===
  # depend: $1-top.v
  ncverilog $1-top.v ‘cget $1 VDEFINES‘ ‘cget $1
VFILES‘ +PLITEST=$2 ‘cget $1 PLIARGS‘ −1 $2-$1.log
```

Template Pre-Processor

The template pre-processor generates text files based on a file template and a collection of named parameters. The named parameters are extracted from a configuration object, in one embodiment. Shown below is an example of a template file named, “top.v.empy” that is used to generate a top-level test harness module based on the value of a parameter “N”. The value of “N” is extracted from a configuration object. There are many different uses for template pre-processors.

=== top.v.empy ===
module test@N( );
reg in;
@[for i in range(@N):
wire out@N;
]
des@N ides (in, out0 @[for i in range(1,@N): , out@N]);

The above template pre-processor is adapted to automatically generate a top-level test harness for various different, but related designs. For example, consider two different designs, as describe in modules “des1” and “des2” below. The template pre-processor automatically generates a suitable top-level test harness for each of these designs, based on the above file template “top.v.empy” and a configuration object associated with the respective design.

module des1(in, out0);
input in;
output out0;
...
module des2(in, out0, out1);
input in;
output out0;
output out1;
...

The following example is provided to help illustrate how a template pre-processor automatically generates a suitable test harness from the template file and a configuration object. In the example below, two projects have been defined in configuration objects D2 and D4, respectively. The design for the first project has one output, and the second has two outputs. The example configuration objects shown below, “D2” and “D4”, have been given a parameter “N” that gives the number of ports in the variant described by the configuration object. The value of N is extracted and used by the template pre-processor.

```
=== D2 ===
  VDEFINES: “+define+PORTWIDTH2”
  VFILES: “d1.v d2.v”
  PLIARGS: “+PLIARG=2”
  N: 1
  === D4 ===
VDEFINES: “+define+PORTWILDTH4”
VFILES: “d1.v d2.v”
  PLIARGS: “+PLIARG=4”
  N: 2
```

Thus, the template pre-processor automatically generates the following top-level test harness, based on the template file “top.v.empy” and the configuration object “D2”.

module test1( );
reg in;
wire out0;
des1 ides (in, out0);
endmodule

The template pre-processor automatically generates the following top-level test harness appropriate, based on the template file “top.v.empy” and the configuration object “D4”.

module test2( );
reg in;
wire out0;
wire out1;
des2 ides (in, out0, out1);
endmodule

When a user invokes the test script “runtest” with parameters “D2 t1”, the file dependency checker determines that the invocation of the test script depends on the existence of file “D2-top.v.” If the file is not present, the template pre-processor automatically generates it using the template “top.v.empy” and the value associated with the key “N” from configuration object “D2.”

In one embodiment, the environment automatically executes the following command to generate the missing file based on the configuration specified, wherein “em.py” invokes a template preprocessor.

% em.py−DN=1-o D₁-top.v top.v.empy

Fill in Template File

In the previous example, the template file was used in the automatic generation of a test harness. The template file can be used to generate many other types of files. Furthermore, rather than using the template file in the generation of another file, the template file is filled in with values that are extracted from the configuration object, in one embodiment.

### Remote Job Execution Wrapper

Remote Job Execution (RJE) systems manage large farms of compute servers. To aid in the selection of the “right server” for the “right job” a user may attach resource requirements to a job request to help the RJE system choose a server appropriate for the job. To run a job on a server, a user invokes the RJE program (“rje”) which arranges for the user program (“pgm”) to run on an appropriate compute server. In this model, the user specifies characteristics of the compute server required for the job and the RJE system chooses an appropriate server. The user may also specify that the running of a job will consume a license or other resource. With this information, the RJE system can manage license use so that the number of jobs using a particular license does not outnumber the available licenses.

For example, a user may have a program that only runs on a SUN machine and consumes a LIC license. The RJE system chooses from its collection of SUN servers for the remote execution of the job when a LIC license is available.

The job submitted by the user may be executable a variety of server types. However, the user may not know what type of server the RJE system will select until after the RJE system has made a selection. The actual program to be run may depend on what machine is selected. Consider the situation when a user can use either a program “SUNpgm” on a SUN system or an “HPpgm” on an HPUX system, but cannot use a LINUX system. An RJE wrapper allows a desired program to be selected after a host has been selected, in accordance with an embodiment.

In another case, a user might need to request a compute server with a minimum size of memory to effectively run a program. Upon activation on an actual compute server with a known amount of available memory, the program may require a “memory limit” flag passed to it that corresponds to the actual memory. Such a parameter cannot be optimally fixed before the RJE system has allocated a particular host for the running of the job. However, an RJE wrapper forms program arguments related to job dispatching after the job has landed on a host machine, in accordance with an embodiment.

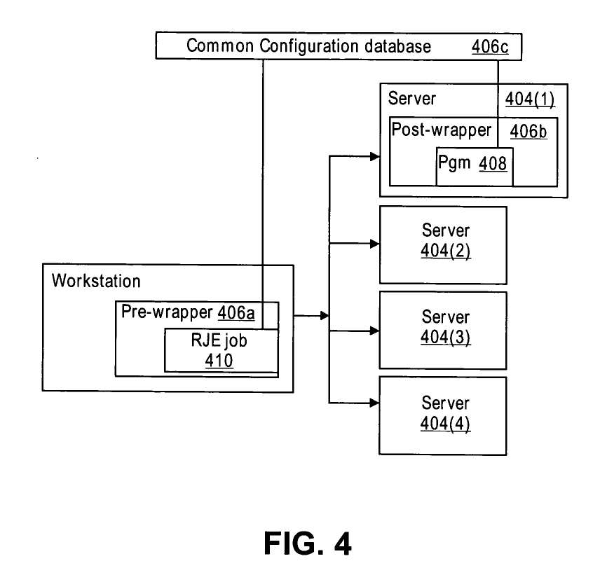

FIG. 4 illustrates a system that includes a remote job execution (RJE) wrapper, in accordance with an embodiment. The RJE separates job running requirements into those that need to be specified as constraints to the RJE system and those decisions that must be made after the job has begun execution on the compute server. The RJE allows deferring certain decisions until after the job has landed on a server, in accordance with an embodiment. For example, the selection of which simulation tool to run can be made after a server is selected for running the job.

Referring to FIG. 4, the RJE wrapper includes three parts: a workstation-side pre-wrapper 406a, a server-side post-wrapper 406b, and a common configuration database 406c that ties the pre-wrapper 406a and post-wrapper 406b together. The database 406c may be a repository for both data and executable code. For example, the database 406c may contain constraints that are used to select an appropriate server on which to execute the job. The database 406c may also contain executable code that can be used to configure a compute environment on the selected server. For example, after the server has been selected, and its characteristics are known, the executable code can be accessed from the database and executed to configure the compute environment on the selected server.

The wrapper 406 takes abstract remote job requirements, and a program 408 to run. Based on the requirements and the program 408, it builds job requirements for the RJE system. Also, based on these requirements, the post-wrapper 406b builds an environment appropriate for the program 408 on the compute server 404, and re-formulates program flags and options as necessary to satisfy the original job requirements. In one embodiment, the post-wrapper 406b builds a UNIX environment.

### Example of Remote Job Execution

A user submits a job requesting reservation of lic LIC for the program 408 and plugLIC for the plug-in, usage of an architecture-specific plug-in module called PLUG and willing to accept SUN or BP. The pre-wrapper 406a consults configuration database 406c and formulates RJE job 410 to invoke post-wrapper 406b on one of the compute servers 404.

The RJE system waits until LIC and a SUN or HP is available. The RJE system starts post-wrapper 406b on a SUN server (e.g., server 404(1)). The post-wrapper 406b examines the request to start PGM with plug-in PLUG and notices that it is executing on a SUN machine. Post-wrapper 406b also consults the configuration database 406c. For example, the post-wrapper 406b obtains executable code from the database 406c that is able to configure the compute environment. The post-wrapper 406b configures a compute environment appropriate for running jobs on a SUN machine, including setting PATH to find the SUN version of the PGM, called sunPGM, and the SUN version of the plug-in, called sunPLUG. Starting the program with the plug-in may be achieved by executing a command such as:

−% sunPGM −plug sunPLUG

As another example, initially it might be known that the simulator tool should be Verilog 3.4 with plug-in 1.0. However, prior to the job being assigned a particular server, it is unknown what type of server the job will land on. Therefore, certain server specific parameters relevant to the simulation tool are unknown. In this example, if the post-wrapper 406b wakes up and discovers that the server is a LINUX server, it will set up parameters such that Verilog 3.4 with plug-in 1.0 works on the LINUX server.

The RJE wrapper technique avoids the need to specify that the job execute on a particular type of server. Thus, the RJE wrapper allows the job to be executed on a wide variety of server platforms.

An embodiment in accordance with the present invention is a machine implemented method of remotely executing a job. The method comprises the following steps. A request is received to execute a job on a server of a plurality of servers. A remote execution job is formulated to satisfy the job request. The remote execution job is configured to invoke a post-wrapper process on the server. After a server has been selected for execution of the job, but prior to executing the job, the post-wrapper process is invoked on the selected server. The post-wrapper process determines at least one characteristic of the server on which it is invoked. The at least one characteristic of the selected server is uncertain prior to identification of the selected server. The configuration database is accessed to locate an object that is operable to facilitate configuring a compute environment on the selected server, based on the at least one characteristic of the selected server. The compute environment is configured on the selected server by using the object. The object comprises executable code, in accordance with one embodiment.

### Verification Environment Navigator

A verification environment contains a wide range of information. Making sense of all the information can be difficult. There are design files, test files, scripts, and many log files produced as the result of running simulations. The running of simulation jobs is complicated, and may require long Unix command lines. Traversing this mass of information to find interesting results can be tedious.

A verification environment navigator is provided in accordance with an embodiment. The verification environment navigator is an application that presents a graphical representation of information in the environment, creates summaries of regressions, shows available computing resources in the enterprise and runs further simulation jobs. Thus, the verification environment navigator allows examination of personal verification environment, including but not limited to, log files, information objects, design files, testbench files, and test scenario files.

There is one navigator process per verification environment, in one aspect. However, one user may have multiple environments and many navigators can exist on a given machine. One implementation is a custom webserver per workspace. Non-HTML versions are possible as well.

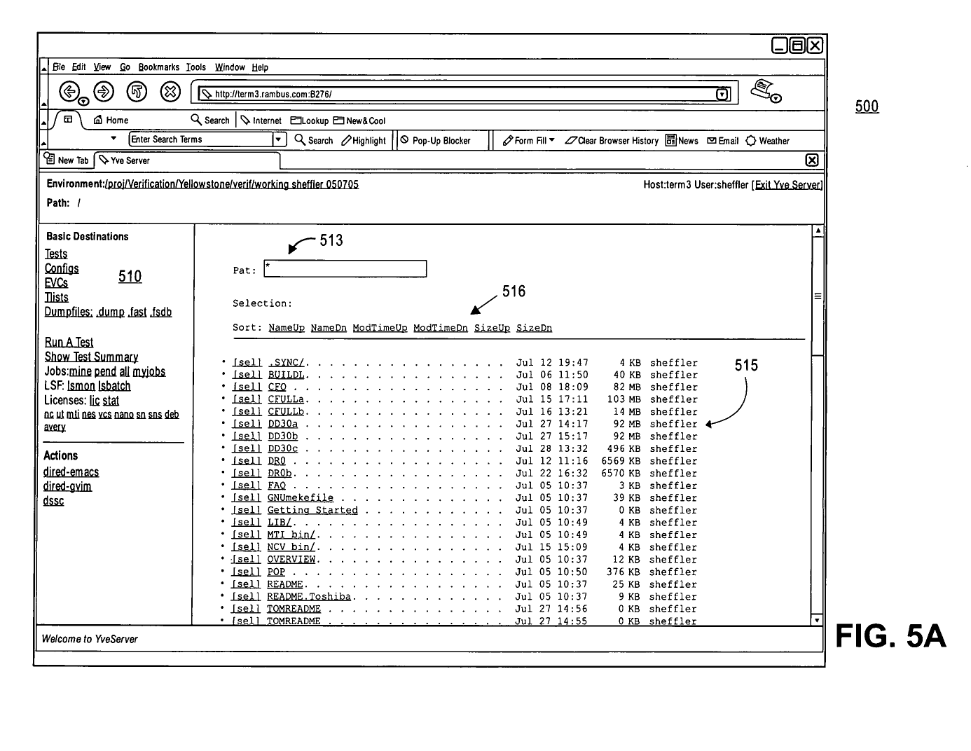

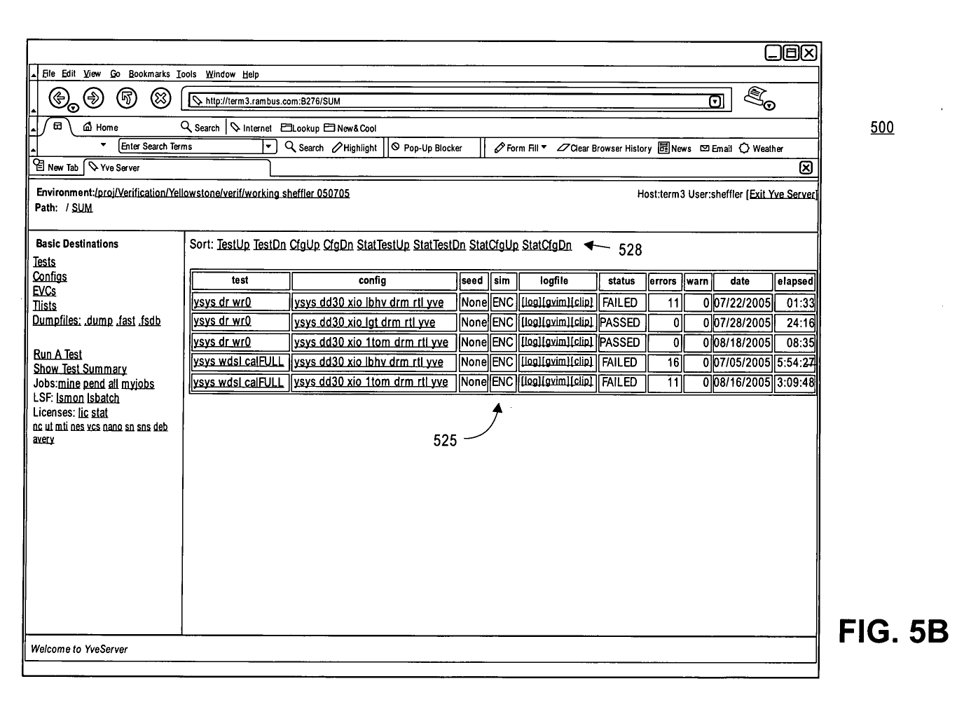

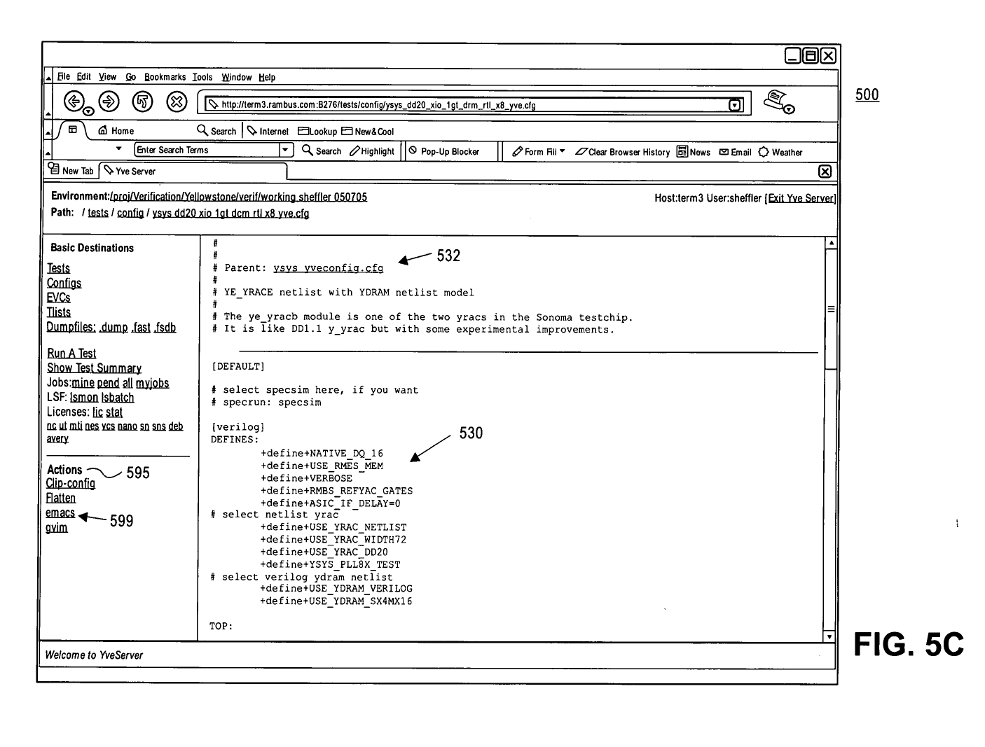

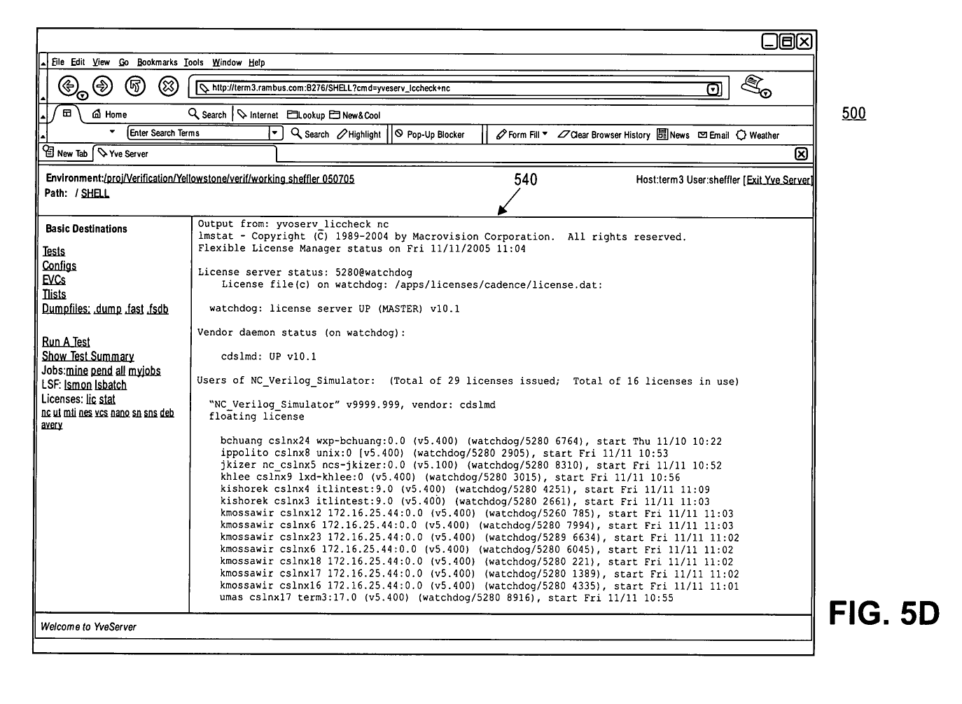

FIG. 5A-5D show different screens of a verification environment navigator, in accordance with an embodiment. FIG. 5A shows an initial screen 500 greeting a new user, in accordance with an embodiment. The navigation pane 510 shows basic destinations and test information 515. The test information 515 can be sorted by the selectable “buttons” 516. Among other tasks, the navigator presents a summary and allows manipulation of log information. For example, the navigator allows a user to open a log file, find errors, jump to the line indicated by error, and to look at regression summaries sorted in various ways (e.g., name, pass/fail, date, etc.).

The pattern box 513 allows a user to enter a pattern, which is associated with a particular project. For example, the pattern may be based on the name of a configuration object. The verification environment navigator displays results that are associated with the particular project. As previously discussed, files that are associated with a particular project may be named to uniquely associate the files with the particular project. The verification environment navigator uses this fact, along with an understanding of how the files are organized in order to locate files associated with the particular project for display. For example, if the user selects “.dump” in the basic destinations 510, then the navigator would display “dump” files associated with the particular project that is identified in the pattern box 513.

FIG. 5B shows a navigator screen 500 with an example regression summary 525 with “buttons” 528 that allow the user to sort the regression in a number of ways. An extensible plug-in architecture allows custom rendering of verification objects applying environment specific markup, in accordance with an embodiment.

FIG. 5C illustrates a rendering (in HTML) of an information object 530, in accordance with an embodiment. An information object may reference another through the parent directive 532. The parent directive 532 is a hyperlink to another information object, in one embodiment.

The file-type architecture also allows attachment of custom actions to specific file types. Associated tools may be launched for viewing various objects (e.g., dump files). File object type identification allows type-specific operations to be presented to the user for common operations. For example, a “config” file presents user with an “edit” option with emacs 599 in the actions 595. As another example, a “dump” file presents user with “view using nwave” option.

The verification environment navigator also provides status information of the computing environment at large. For example, status related to tool license availability and compute server availability can be presented in a convenient manner. The window 540 in the screen 500 of FIG. 5D presents information license information, such as the number of NC Verilog licenses in use and reserved.

### Verification Environment Navigator Recap

The verification environment navigator allows the launching of verification tasks. Typically, the launching of a verification job requires selecting from a myriad of parameters. The combination of the re-useable verification environment discussed herein and the verification environment navigator allows very convenient job submission. The verification environment navigator is a very convenient way of working with the configuration objects discussed herein.

Most job runs for testing a design of a circuit include specifying a design configuration, a test to run over the design, a simulation tool to run the test on, parameters for the simulator, and information for remote job execution. The verification environment navigator provides a very convenient user interface for selecting the information needed to execute testing a design of a circuit.

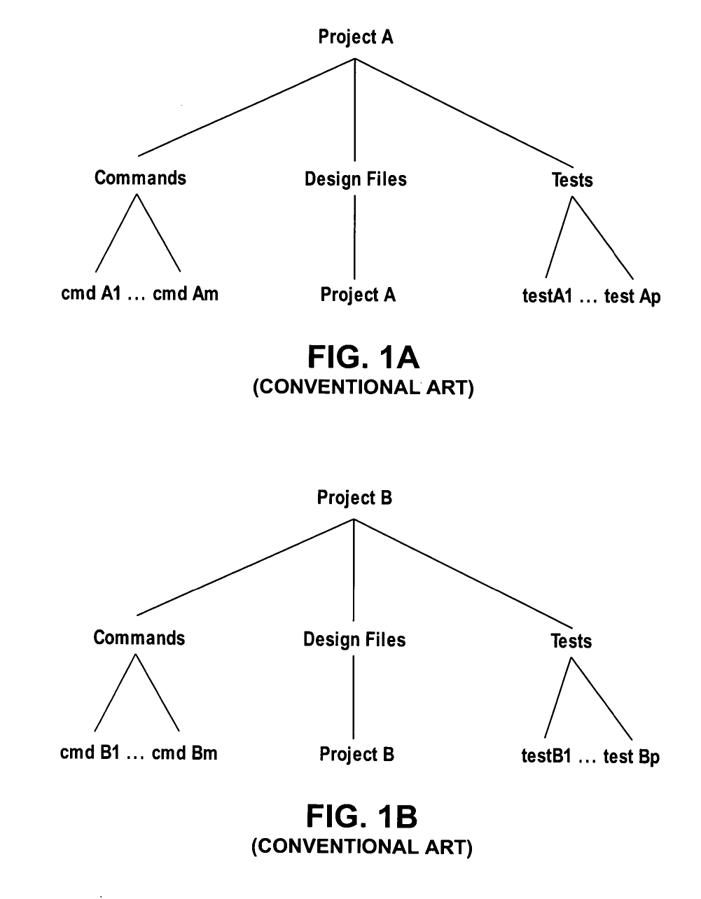

An embodiment in accordance with the present invention is a machine implemented method of displaying project information in a multi-project testing environment comprising the following steps. A user interface adapted to display project information is provided. A project identifier that identifies a particular project in the multi-project testing environment is received in the user interface. For example, the user interface receives an identifier in the pattern box (FIG. 1, 513), wherein the identifier is based on the name of a configuration object. Directory information is accessed that describes the way in which the project information is organized in the multi-project testing environment. FIG. 2 illustrates a high-level diagram of a project directory. However, a project directly may be more complex. In general, the directory may describe an organization for storing various files associated with multi-project testing environment. Files associated with the particular project are located based on the directory information and the project identifier. As previously discussed, the files may be named to uniquely associate the files with the particular project. Thus, the files associated with the particular project may be easily located. The navigator displays the project information related to the files that are associated with the particular project.

### Named Tunnel for HDL Simulation

A software PLI application allows modules to communicate without using wires, in accordance with an embodiment. Such a facility might be useful for certain types of behavioral modeling; however, the uses are not so limited. A PLI application which presents an abstraction of “named tunnels” is provided in an embodiment. A tunnel is a communication channel that does not correspond to a hardware entity (e.g., a wire).

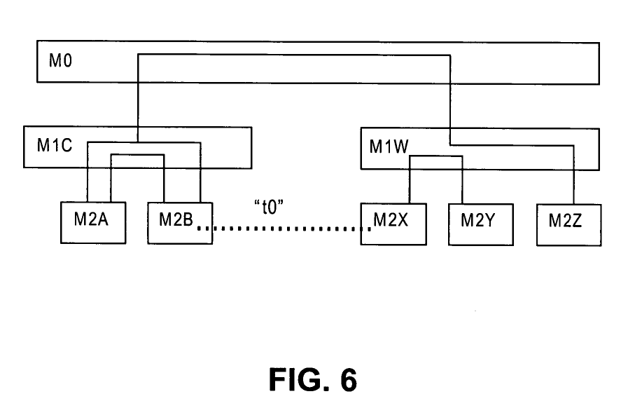

FIG. 6 shows an example augmented with a tunnel from module M2B to M2X. The name of the tunnel is “t0.” An HDL driver is attached to a tunnel with a special PLI function. An HDL receiver is attached to a tunnel with a different PLI function. For instance, a module that drives a tunnel might contain the following PLI function call.

module m2b
reg r;
initial
$tundrvr(“t0”, r);

A module receiving from a tunnel, might contain a PLI function call like the one below.

module m2x
wire w;
initial
$tunrcvr(“A”, w);

In one case, the PLI application arranges for simulation events registered on the driver HDL entity to be re-transmitted on the corresponding receiver. Thus, the tunnel has a single driver and receiver a tail. Values asserted by the driver are seen by the receiver. However, many receivers may attach to the same driver.

As another variant, many drivers may be used with many receivers. In still another variant many drivers are used with a single receiver. When using many drivers, a driver-resolution function may be used.

The PLI application should present a number of name resolution protocols for tunnels. A simple flat namespace is used in one aspect. In this embodiment, a string name uniquely identifies the tunnel. A hierarchical namespace corresponding to the design hierarchy is used in another aspect. A hierarchical namespace may be useful for making reusable designs that may be instantiated multiple times without interfering with one another. In the hierarchical namespace aspect, a name in one module matches the “nearest” corresponding driver/receiver in the hierarchy. Here, “nearest” is defined as the mate with the deepest least-common-ancestor in the design hierarchy.

### Hardware Overview

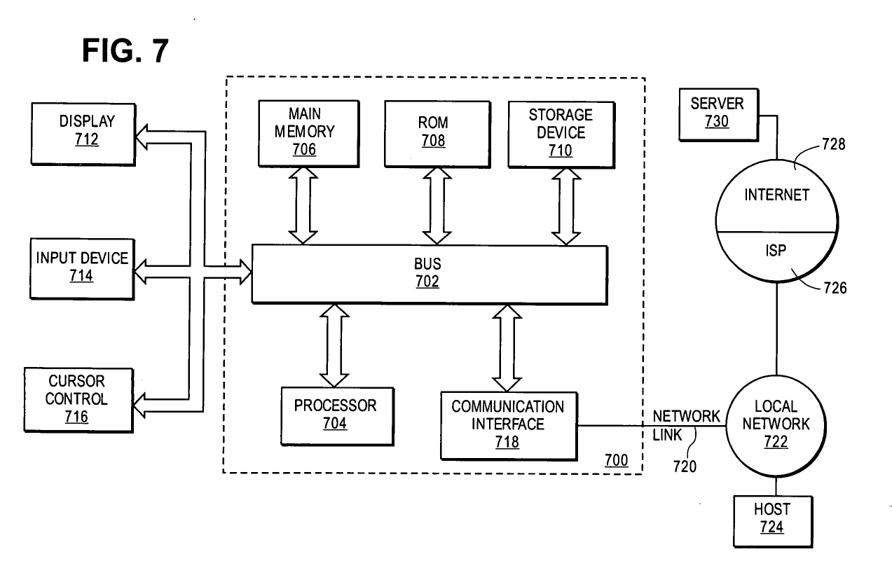

FIG. 7 is a block diagram that illustrates a computer system 700 upon which an embodiment may be implemented. Computer system 700 includes a bus 702 or other communication mechanism for communicating information, and a processor 704 coupled with bus 702 for processing information. Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

An embodiment is related to the use of computer system 700 for implementing the techniques described herein. According to one embodiment, those techniques are performed by computer system 700 in response to processor 704 executing one or more sequences of one or more instructions contained in main memory 706. Such instructions may be read into main memory 706 from another machine-readable medium, such as storage device 710. Execution of the sequences of instructions contained in main memory 706 causes processor 704 to perform the process steps described herein. In alternative embodiments, hard-wired circuitry may be used in place of or in combination with software instructions. Thus, embodiments are not limited to any specific combination of hardware circuitry and software.

The term “machine-readable medium” as used herein refers to any medium that participates in providing data that causes a machine to operation in a specific fashion. In an embodiment implemented using computer system 700, various machine-readable media are involved, for example, in providing instructions to processor 704 for execution. Such a medium may take many forms, including but not limited to, non-volatile media, volatile media, and transmission media. Non-volatile media includes, for example, optical or magnetic disks, such as storage device 710. Volatile media includes dynamic memory, such as main memory 706. Transmission media includes coaxial cables, copper wire and fiber optics, including the wires that comprise bus 702. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 704 for execution. For example, the instructions may initially be carried on a magnetic disk of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are exemplary forms of carrier waves transporting the information.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution. In this manner, computer system 700 may obtain application code in the form of a carrier wave.

In the foregoing specification, embodiments have been described with reference to numerous specific details that may vary from implementation to implementation. Although the disclosure has been described with reference to specific exemplary embodiments thereof, it will be evident that various modifications and changes may be made thereto without departing from the broader spirit and scope of the disclosure as set forth in the appended claims. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising performing a machine-executed operation involving instructions, wherein the machine-executed operation is at least one of:
A) sending said instructions over transmission media;
B) receiving said instructions over transmission media;
C) storing said instructions onto a machine-readable storage medium; and
D) executing the instructions;
wherein said instructions are instructions which, when executed by one or more processors, cause the one or more processors to perform the steps of:
storing configuration information for each of a plurality of projects;
wherein the configuration information for each of the projects specifies at least circuit design files for the project and project specific information relating to circuit related tests to be run on the circuit design files for the project;
receiving a request to perform a particular circuit related test on a particular project;
reading the configuration information corresponding to the particular project; and
executing the particular circuit related test based on the configuration information for the particular project.

2. The method of claim 1, wherein the project specific information relating to circuit related tests specifies a simulation tool on which the circuit related tests should be executed.

3. The method of claim 1, wherein the project specific information relating to circuit related tests specifies one or more parameters to input to a simulation tool on which the circuit related tests should be executed.

4. The method of claim 1, wherein the project specific information relating to circuit related tests specifies one or more flags to input to a simulation tool on which the circuit related tests should be executed.

5. The method of claim 1, wherein the project specific information relating to circuit related tests specifies one or more parameters to input to a circuit related test to be run on the circuit design files for the project.

6. The method of claim 1, wherein the project specific information comprises a list of circuit related tests to be run on the circuit design files for the project.

7. The method of claim 1, wherein said instructions are instructions which, when executed by one or more processors, cause the one or more processors to perform the further step of:
parameterzing, based on the configuration information corresponding to the particular project, a test script file for running the particular circuit related test, wherein the test script file is adapted to be used for the plurality of projects by parameterzing said test script file based on the configuration information from one of the projects.

8. The method of claim 1, further comprising generating configuration information corresponding to a first of the projects based on configuration information corresponding to a second of the projects.

9. The method of claim 1, further comprising automatically generating a test file that is appropriate for the particular project based on the configuration information for the particular project.

10. The method of claim 1, further comprising generating test result files for the particular project that are named to uniquely associate the test result files with the particular project.

11. The method of claim 10, wherein the test result files comprise a log file.

12. The method of in claim 10, wherein the test result files comprise an intermediate file.

13. A machine implemented method of implementing a multi-project testing environment, comprising:
accessing circuit design files that are adapted to be used to describe a plurality of projects, wherein each of the projects is representative of a circuit design;
accessing one or more test programs that have an input arguments for specifying which project of the projects is to be tested by the test program;
storing configuration information for each of the plurality of projects;
wherein the configuration information for a particular project of the projects specifies at least:
one or more of the circuit design files to describe the particular project; and
project specific information that is useable to parameterize the test programs, wherein the test programs are useable for the plurality of projects by parameterizing the tests programs with the configuration information.

14. The machine implemented method of claim 13, further comprising accessing a command for invoking one of the tests programs, wherein the command is adapted to be used for testing the plurality of projects by specifying a particular project as an argument to the command.

15. The machine implemented method of claim 13, further comprising generating a verification environment for a new project by:
storing configuration information for the new project, wherein the configuration information for the new project specifies at least:
ones of the circuit design files to describe the new project; and
project specific information that is useable to parameterize the test programs.

16. The machine implemented method of claim 13, wherein the project specific information that is useable to parameterize the test programs specifies a simulation tool on which a test should be executed.

17. The machine implemented method of claim 13, wherein the project specific information that is useable to parameterize the test programs specifies one or more parameters to input to a simulation tool on which a test should be executed.

18. The machine implemented method of claim 13, wherein the project specific information that is useable to parameterize the test programs specifies one or more flags to input to a simulation tool on which a test should be executed.

19. The machine implemented method of claim 13, wherein the project specific information that is useable to parameterize the test programs specifies one or more parameters to input to a circuit related test to be run on the circuit design files that describe the project.

20. The machine implemented method of claim 13, wherein the project specific information that is useable to parameterize the test programs comprises a list of circuit related tests to be run on the circuit design files that describe the project.

21. The machine implemented method of claim 13, further comprising:
parameterizing a test program for running the test against a particular project, based on the project specific information for the particular project.

22. The machine implemented method of claim 13, further comprising generating configuration information corresponding to a first of the projects based on configuration information corresponding to a second of the projects.

23. The machine implemented method of claim 13, further comprising automatically generating a test file that is appropriate to test a particular project based on the configuration information for the particular project and a template file.

24. The machine implemented method of claim 13, wherein the test programs comprise test scripts.

25. The machine implemented method of claim 13, further comprising generating a test result file that is named to uniquely identify the particular project.

26. The machine implemented method of claim 13, wherein the test result file is a log file.

27. The machine implemented method of claim 13, wherein the test result file is an intermediate file.

28. A machine implemented method of executing a job, comprising the steps of:
receiving a job request to execute the job on a server of a plurality of servers;
formulating a remote execution job to satisfy the job request, wherein the remote execution job is configured to invoke a process on the selected server prior to executing the job on the selected server;
after a server has been selected for execution of the job, invoking the process on the selected server, wherein the process determines at least one characteristic of the server on which it is invoked, and wherein the at least one characteristic of the selected server is uncertain prior to identification of the selected server;
accessing a database to locate an object that is operable to facilitate configuring a compute environment on the selected server based on the at least one characteristic of the selected server; and
configuring the compute environment on the selected server by using the object.

29. The machine implemented method of claim 28, wherein the step of formulating a remote execution job comprises accessing the database to determine one or more constraints to satisfy the job request, wherein the constraints are used to select the server.

30. The machine implemented method of claim 28, wherein the object comprises executable code, and wherein configuring the compute environment comprises executing the code.

31. The machine implemented method of claim 28, wherein the step of configuring the compute environment comprises forming program arguments relating to the job request.

32. The machine implemented method of claim 28, wherein the step of configuring the compute environment comprises selecting a program execute on the selected server in order to satisfy the job request.

33. A machine implemented method of displaying project information in a multi-project testing environment, comprising the steps of:
providing a user interface adapted to display project information;
receiving, in the user interface, a project identifier that identifies a particular project in the multi-project testing environment;
accessing directory information that describes how the project information is organized in the multi-project testing environment;
locating files that are associated with the particular project, wherein the step of locating is based on the directory information and the project identifier, and wherein files associated with the particular project are named to uniquely associate the files with the particular project; and
displaying project information related to the files that are associated with the particular project.

34. The machine implemented method of claim 33, further comprising:
receiving a request to display a class of files associated with the particular project;
locating files related to the class of files and the particular project; and
displaying project information related to the class of files that are associated with the particular project.
